(19) United States
(12) Patent Application Publication
(10) Pub. No.: US 2003/0110486 A1
(43) Pub. Date: Jun. 12, 2003

(54) System and method for reviewing on screen TV programs

(75) Inventors: Aaron Dew, San Diego, CA (US); Greg Gudorf, San Diego, CA (US); Anthony Lionel Creed, San Diego, CA (US); Matthew Chang, San Diego, CA (US); William Hausch, Culver City, CA (US)

Correspondence Address: John L. Rogitz, Rogitz & Associates, 750 B Street, Suite 3120, San Diego, CA, 92101, US

(73) Assignees: SONY CORPORATION, Toyko (JP); SONY ELECTRONICS INC., Park Ridge, NJ

(21) Appl. No.: 10/000,562

(22) Filed: Oct. 31, 2001

(51) Int. Cl. H04N 7/16; H04H 9/00; H04N 7/173; G06F 3/00; H04N 5/445; G06F 13/00

(52) U.S. Cl. 725/24; 725/13; 725/39; 725/40

(57) ABSTRACT

A system and method for enhancing viewer group enjoyment of a TV program. An input device is used to input reviews of a televised program, with each viewer having his or her own icon and with a viewer's review being superimposed on the TV program (including an electronic program guide) along with the icon as the review is input or at a later, more appropriate time.

### BACKGROUND OF THE INVENTION

1. Field of the Invention

The present invention relates generally to television systems.

2. Description of the Related Art

Televisions and computers have become ubiquitous, and since both usually entail a visual display, efforts have been made to integrate both functions into a single system. In this way, a consumer need not purchase and operate two separate systems, which can burden some consumers who, while familiar with operating a television and its remote control, might not be familiar with operating, e.g., an Internet computer.

To the extent that attempts have been made to combine television with Internet features, it has generally been with the focus of producing what might be thought of as a “lean forward” system. That is, hybrid TV/computers have typically been more oriented toward productivity, generally thought of as a computer system characteristic, and less toward entertainment (“lean back”), generally regarded as a television system characteristic. It is not just the dichotomy between productivity and entertainment that distinguishes a “lean forward” experience from a “lean back” experience, however. As contemplated herein, “lean forward” activities often are experienced by only a single person, while “lean back” activities are often group experiences. Moreover, “lean back” activities can extend to purchasing products that are advertised on TV, as opposed to, e.g., making products for sale. In any case, with the above-mentioned critical observation of the present invention in mind, it can readily be appreciated that the differences between a system designed for “lean forward” experiences and a system designed for “lean back” experiences can be both subtle and profound.

An example of a “lean forward” system is the system known as “WebTV”, in which preselected Internet pages are loaded once into a television during manufacture and never subsequently updated, with the preselected pages being accessible through the television using a computer keyboard with its attendant complexity. To access the pages, the consumer must access a central site by means of the keyboard, and then be redirected to a desired Web page. In terms of currently expected speeds of Internet access, this consumes an undue amount of time. Furthermore, it requires browser or browser-like operations that must be executed by a consumer. All of these features—use of a keyboard, knowledgeable use of a browser, and wait time for Web page access—are not per se unacceptable for a lean forward experience, but would severely detract from a lean back experience.

For instance, in the context of lean back, entertainment- and group-oriented experiences, consumers are accustomed to using a much simpler input device than a computer keyboard, namely, a remote control. Moreover, a user interface that is simpler than a Web browser, e.g., an electronic program guide (EPG), is preferred. Also, waiting for entertainment to load or otherwise be prepared for playing is distracting in a lean-back, group-oriented experience. But as exemplified above by the WebTV system, current systems that attempt to integrate television and computers essentially do so by grafting a TV onto what is essentially an underlying, lean forward computer system, and consequently provide less than optimum lean back experiences. As an example, in a group lean back experience, several viewers might wish to share their opinions of a program with others viewing the program, without interrupting the viewing experience of the others by making verbal comments. The object of the present invention is to provide a TV system that accommodates lean back experiences better than existing systems.

### SUMMARY OF THE INVENTION

The invention provides a fun and unobtrusive way for members of a group of people watching a TV program or an individual watching a TV program on a device shared by a group to display opinions on-screen regarding the programs.

A method for presenting viewer reviews regarding a TV program on a TV includes correlating icons to respective viewers, and receiving viewer reviews. The viewer reviews are presented with associated icons on a TV, along with a TV program and/or an electronic program guide that lists channels. Preferably, the reviews are stored in a database.

In a preferred embodiment, the reviews are correlated to respective viewers. Desirably, a viewer can be allowed to select an icon from a list of icons that can be presented on the TV. A review can be presented when made, or at a viewer-determined time or automatically-determined time that is later than a time the review was made. As set forth below, the reviews can be presented as text, graphics, audio, or a combination thereof.

In another aspect, a system for enabling TV viewers to input respective reviews on a TV includes the TV and a processor associated with the TV that receives the reviews. The processor correlates each review to a respective viewer and causes the review to be displayed on the TV along with an icon representing an associated viewer.

In still another aspect, a method for promoting enjoyment of TV viewing includes allowing TV viewers to select respective icons from a set of icons. The method also includes receiving viewer reviews, and correlating each review to a respective icon. The reviews are superimposed on a TV program display/EPG.

### BRIEF DESCRIPTION OF THE DRAWINGS

The details of the present invention, both as to its structure and operation, can best be understood in reference to the accompanying drawings, in which like reference numerals refer to like parts, and in which:

FIG. 1 is a block diagram of the system of the present invention; and

FIG. 2 is a flow chart of the review logic.

### DETAILED DESCRIPTION OF THE PREFERRED EMBODIMENTS

This invention provides a way for TV viewers to input reviews regarding TV programming and having the opinions displayed in some fashion on the TV, superimposed over the TV image and/or an accompanying electronic program guide (EPG).

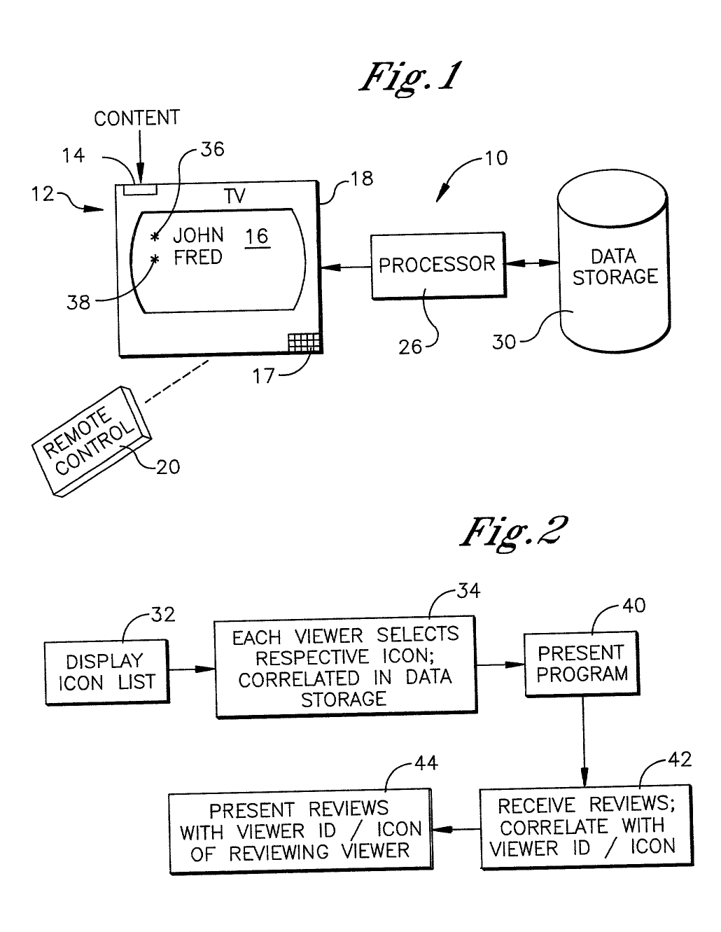

Referring initially to FIG. 1, a system is shown, generally designated 10. As shown, the system 10 includes a TV 12 that conventionally receives televised content at a content receiver 14 (e.g., an antenna, satellite dish, set-top box, etc.) for display of the content on a monitor 16 and associated speakers 17. The content receiver may include or be coupled to a storage device, such that the below-described programming opinions/comments can be made on recorded content, as well as real-time broadcast content.

While the embodiment below discusses a TV 12 with a single housing that is shown separate from the microprocessor and database, it is to be understood that the term “television” encompasses any apparatus that has a television tuner or is capable of storing television program content, and that also has the below-described capability in a single housing or in separate housings that cooperate together. For instance, the term “TV” encompasses the television system shown in FIG. 1, as well as a conventional television in combination with a set-top box that functions in accordance with the present invention. In the latter example, the set-top box might include, e.g., the microprocessor discussed below.

In the preferred non-limiting embodiment shown, the TV 12 includes a housing 18 that holds a conventional television tuner which receives the TV signals. One or more viewer input devices, such as but not limited to a wireless TV remote control device 20, can be used to input the below-described reviews and icon selections to the TV 12 and, hence, to the processor discussed below.

More particularly, a microprocessor 26 communicates with the TV circuitry for presenting viewer icons/reviews on the monitor 16/speakers 17 in accordance with the disclosure below. As intimated above, the microprocessor 26 can be located in the housing 18 or it can be disposed elsewhere, such as in a set-top box, remote control device, or other component. In any case, the microprocessor 26 executes the logic set forth herein. The microprocessor 26 can also access a database 30 of viewer information, with the database 30 being contained in computer memory, or on a hard disk drive, optical drive, solid state storage, tape drive, removable flash memory, or any other suitable data storage medium and potentially accessible to a network such as the Internet.

It is to be understood that the microprocessor 26 controls certain functions of the TV 12 in accordance with the logic below. The flow charts herein illustrate the structure of the logic modules of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer or microprocessor) to perform a sequence of function steps corresponding to those shown. Internal logic could be as simple as a state machine.

In other words, the present logic may be established as a computer program that is executed by a processor within, e.g., the present microprocessors/servers as a series of computer-executable instructions. In addition to residing on hard disk drives, these instructions may reside, for example, in RAM of the appropriate computer, or the instructions may be stored on magnetic tape, electronic read-only memory, or other appropriate data storage device.

According to present principles, viewers can generate reviews of televised programs using the remote control device 20, and associate their identities (and, thus, their reviews) with icons that represent individual viewers. With this in mind, as shown in FIG. 2 at block 32 an icon list initially can be displayed on the TV 12 monitor in response to a viewer toggling a “display icons” button on the remote control device 20 or in response to other signals. Each viewer can then select an icon at block 34 by highlighting the desired icon in the list and then typing in the viewer's name by means of, e.g., a keypad on the remote device 20. The icons with names are stored in the database 30.

Referring back briefly to FIG. 1 to understand what one TV 12 might look like after the step at block 34, a first icon 36 (a star) is shown beside the associated viewer's name, which in the example shown is “John”. Also, a second icon 38 (a plus sign) is shown beside the associated viewer's name, which in the example shown is “Fred”.

Proceeding to block 40, a TV program, either real-time broadcast or recorded and stored locally in the TV, is displayed on the TV 12. Moving to block 42, viewer reviews are received by the TV 12 and sent to the processor 26. These reviews can be input by means of, e.g., a keypad on the remote control device 20. Or, the remote control device 20 can include special buttons with pre-stored review comments such as “great”, “gag”, etc. Still again, the numerals “1” through “5” of a keypad on the remote control device 20 can respectively indicate a five point scale from “excellent” through “poor” regarding the viewer's opinion of the program being televised. In any case, in making a review a viewer identifies himself by means of the input device by, e.g., causing the viewer's icon to be displayed on the TV while the review is being input, so that the review is correlated in the database 30 with the reviewing viewer.

Thus, the processor 26 correlates the review results with the appropriate viewer icon. The reviews can also be stored in the database 30, along with the reviewer identity. A legend of icons with associated viewer ID can be presented on demand by a viewer by, e.g., appropriately manipulating the input device.

Then, moving to block 44, the review results are displayed on the monitor 16 and/or speaker 17 at the time of review or at a later time when, for instance, another person might view the TV and recall a stored program with attendant comments. As an example, appropriate review text as input by a viewer can be superimposed on the monitor 16 or potentially amusing graphics such as additional icons representing various review comments can be superimposed on the monitor 16. Or, audio results can be superimposed over the TV audio displayed via the speakers 17 by playing a clip of, e.g., “Superb!” After a predetermined period, e.g., five seconds, the text/graphics can be removed from the monitor 16. Or, a viewer toggling a button on the remote device 20 can remove review results from the screen. Indeed, if desired in some implementations a viewer can disable the presentation of review results altogether by appropriately manipulating the remote device 20.

As mentioned above, the step at block 44 can be undertaken as soon as a viewer inputs a review. Also, the review can be stored and presented at a later time as defined by the reviewing viewer. For example, a viewer might decide that a review comment input while the viewer is alone be displayed hours later, when another viewer might be expected to use the TV 12, during a rebroadcast of a news service or other program. In such a case, the review would be retrieved from the database 30 at the appropriate time and then displayed on the monitor 16 along with the reviewing viewer's icon.

Reviews and viewer identities can also be uploaded to a server via the Internet, for use in further marketing/e-commerce.

While the particular SYSTEM AND METHOD FOR REVIEWING ON SCREEN TV PROGRAMS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

We claim:

1. A method for presenting viewer reviews regarding a TV program on a TV, comprising:
correlating at least first and second icons to respective first and second viewers;
receiving at least first and second viewer reviews; and
presenting the viewer reviews with associated icons on a TV, along with a TV program or an electronic program guide.

2. The method of claim 1, wherein the viewer reviews are input using at least one wireless input device communicating with the TV.

3. The method of claim 1, further comprising storing at least one review in a database.

4. The method of claim 1, further comprising correlating the reviews to respective viewers.

5. The method of claim 1, further comprising allowing a viewer to select an icon.

6. The method of claim 1, further comprising presenting a list of icons on the TV.

7. The method of claim 1, wherein a review is presented when made.

8. The method of claim 1, wherein a review is presented at a viewer-determined time later than a time the review was made.

9. The method of claim 1, wherein the reviews are presented as text.

10. The method of claim 1, wherein the reviews are presented graphically.

11. The method of claim 1, wherein the reviews are presented audibly.

12. A system for enabling TV viewers to input respective reviews on a TV, comprising:
a TV; and
a processor associated with the TV and receiving the reviews,
the processor correlating each review to a respective viewer,
the processor causing the review to be displayed on the TV along with an icon representing an associated viewer.

13. The system of claim 12, wherein the processor stores at least one review in a database.

14. The system of claim 12, wherein the processor allows a viewer to select an icon.

15. The system of claim 12, wherein the processor presents a list of icons on the TV.

16. The system of claim 12, wherein the processor displays a review when the review is made.

17. The system of claim 12, wherein the processor displays a review at a viewer-determined time later than a time the review was made, or displays the review any time that a program that has been correlated with the review is displayed.

18. The system of claim 12, wherein the reviews are presented as text.

19. The system of claim 12, wherein the reviews are presented graphically.

20. The system of claim 12, wherein the reviews are presented audibly.

21. A method for promoting enjoyment of TV viewing, comprising:
allowing TV viewers to select respective icons from a set of icons;
receiving viewer reviews;
correlating each review to a respective icon; and
superimposing at least one review with icon on a TV display.

22. The method of claim 21, wherein the TV display is an electronic program guide.

23. The method of claim 21, further comprising storing at least one review in a database.

24. The method of claim 21, further comprising correlating the reviews to respective viewers.

25. The method of claim 21, further comprising presenting a list of icons on the TV.

26. The method of claim 21, wherein a review is presented when made.

27. The method of claim 21, wherein a review is presented at a viewer-determined time later than a time the review was made, or at an automatically-determined time.

28. The method of claim 21, wherein the reviews are presented as text.

29. The method of claim 21, wherein the reviews are presented graphically.

30. The method of claim 21, wherein the reviews are presented audibly.

31. A system for promoting enjoyment of TV viewing, comprising:
means for allowing TV viewers to select respective icons from a set of icon;
means for receiving viewer reviews;
means for correlating each review to a respective icon; and
means for superimposing at least one review with icon on a TV program display.
